(19) United States
(12) Patent Application Publication
(10) Pub. No.: US 2009/0128080 A1
(43) Pub. Date: May 21, 2009

(54) SYSTEM AND METHOD FOR CONTROLLING MULTIPLE SERVO MOTORS

(75) Inventors: Mao-Hsin Cheng, Zhubei City (TW); Ting-Ping Lin, Hsinchu City (TW)

Correspondence Address: Tung & Associates, Suite 120, 838 W. Long Lake Road, Bloomfield Hills, MI, 48302, US

(73) Assignee: Padauk Technology Co.

(21) Appl. No.: 11/941,126

(22) Filed: Nov. 16, 2007

(51) Int. Cl. G05B 11/32

(52) U.S. Cl. 318/625

(57) ABSTRACT

The present invention discloses a method for controlling multiple servo motors, comprising: connecting a first plurality of servo motors in series; providing a corresponding switch in the series connection path for at least every servo motor other than the last one; sequentially setting an ID to each servo motor except the last one, and turning ON the corresponding switch; and setting an ID to the last servo motor.

### FIELD OF THE INVENTION

The present invention relates to a system and a method for controlling multiple servo motors.

### BACKGROUND OF THE INVENTION

There have been quite some researches for robots in the industry. Among many types of robots, human-like or mammal-like robots require quite a number of servo motors to control their joints. A conventional multiple servo motor control system is shown in FIG. 1, in which a main controller 100 individually controls each of a plurality of servo motors #1-#N. In this arrangement, the main controller requires N pins for controlling N servo motors. Referring to FIG. 2, a human-like robot requires 17 servo motors, and therefore the main controller requires 17 corresponding pins.

Each servo motor has three lines: power (VDD), ground (GND) and pulse width modulation (PWM) input control. As shown in FIGS. 1 and 2, the three lines are combined in one group, and each group is connected with the main controller individually. The PWM input control line is a uni-directional line which can only transmit commands from the main controller to a servo motor, but can not transmit the status of a servo motor back to the main controller. Hence, the main controller can not know whether a servo motor has reached its correct position, whether an over current condition occurs in a servo motor, etc.

Because the main controller controls each servo motor individually, this arrangement is advantageous in that it is easier to program. However, it has the following drawbacks: (A) The main controller requires high number of pins, and thus the cost is high. (B) The layout of the wires and the assembly of the servo motors are complicated, because a group of three lines are required for each motor, i.e., 17 groups of 51 lines are required for a human-like robot. The wide distribution of the servo motors creates inconveniences in layout, assembly and maintenance.

Another conventional multiple servo motor control system is shown in FIG. 3, in which the main controller controls the servo motors via a bus structure. The multiple servo motor control bus (MSMCB) operates according to a protocol such as I²C, UART, or a user-defined protocol. There can be one or more signal lines; what is shown is one signal line, for example. Each servo motor has three lines: VDD (not shown), GND (not shown), and MSMCB. The main controller and the servo motors communicate through the MSMCB bi-directionally; that is, the main controller can send commands to the servo motors, and the servo motors can report their status information to the main controller so that the main controller knows the condition of each servo motor, such as its location and whether an over current condition occurs, etc.

The layout of the structure of FIG. 3 in a human-like robot is shown in FIG. 4, in which the solid lines represent external wiring, and the dot lines represent internal wiring. The entire solid and dot lines are connected in series altogether, so actually there is only one signal line. Similar to the prior art shown in FIG. 1, there are two power lines VDD and GND, and one signal line MSMCB.

In the structure shown in FIGS. 3 and 4, because one MSMCB connects all the servo motors, the main controller 200 only requires one pin to control multiple servo motors. However, since the servo motors share the MSMCB, each servo motor needs its own ID for the main controller to identify it. The ID has to be set prior to the assembly of the system, by a specific device. Typically, an EEPROM is provided in each servo motor to store the ID assigned thereto.

This arrangement is advantageous in that the pin number of the main controller is greatly reduced, and the layout of the lines is simplified. However, it has the following drawbacks: (A) Each servo motor requires an ID. In a robot, each motor location corresponds to a predefined ID. Before assembly, the ID of each servo motor must be correctly set according to its location. If any servo motor is to be replaced, a correct ID must be set to the replacing motor manually. (B) The loading of the MSMCB is very heavy because it carries the communication between the main controller and every servo motor.

In view of the foregoing drawbacks in prior art, the present invention proposes a system and a method for controlling multiple servo motors, which simplifies the layout of the lines, and provides an automatic ID setting function, to solve the trouble in assembly and maintenance.

### SUMMARY OF THE INVENTION

A first objective of the present invention is to provide a system for controlling multiple servo motors.

A second objective of the present invention is to provide a method for controlling multiple servo motors.

A third objective of the present invention is to provide a servo motor for use in a multiple-servo-motor system.

To achieve the foregoing objectives, according to an aspect of the present invention, a system for controlling multiple servo motors, comprising: a main controller; a first plurality of servo motors; and a first multiple servo motor control bus (MSMCB) for bi-directional communication between the main controller and each servo motor, the first MSMCB connecting the first plurality of servo motors in series, wherein at least every servo motor other than the last one includes a corresponding switch on the first MSMCB, each switch being initially OFF, and turned ON after an ID is set to its corresponding servo motor, whereby a next servo motor is capable of receiving a signal from the main controller.

According to another aspect of the present invention, a method for controlling multiple servo motors, comprising: connecting a first plurality of servo motors in series; providing a corresponding switch in the series connection path for at least every servo motor other than the last one; sequentially setting an ID to each servo motor except the last one, and turning ON the corresponding switch; and setting an ID to the last servo motor.

In the system and method described above, the last servo motor can optionally be provided with a corresponding switch.

Besides the first plurality of servo motors connected in series, a second plurality of servo motors connected in series may be provided so that the servo motors as a whole are connected partially in series and partially in parallel.

According to yet another aspect of the present invention, a servo motor, comprising: a motor driver; a motor; an ID storing unit for storing an ID; and a switch located on a bus, the bus providing communication with a device external to the servo motor, wherein the switch is initially OFF, and turned ON after an ID is stored to the ID storing unit.

For better understanding the objectives, characteristics, and effects of the present invention, the present invention will be described below in detail by illustrative embodiments with reference to the attached drawings.

### BRIEF DESCRIPTION OF THE DRAWINGS

FIGS. 1 and 2 schematically show a conventional structure for connecting multiple servo motors.

FIGS. 3 and 4 schematically show another conventional structure for connecting multiple servo motors, in this arrangement a servo motor requires an ID.

FIG. 5 schematically shows an embodiment of the present invention wherein an ID of a servo motor is set automatically and sequentially; the structure provides more flexibility to a designer.

FIG. 6 shows how the present invention can be applied to a human-like robot.

FIG. 7 explains the process flow for setting the IDs to the servo motors.

FIGS. 8 and 9 show two embodiments as to how a servo motor sets its ID and turns on a corresponding switch.

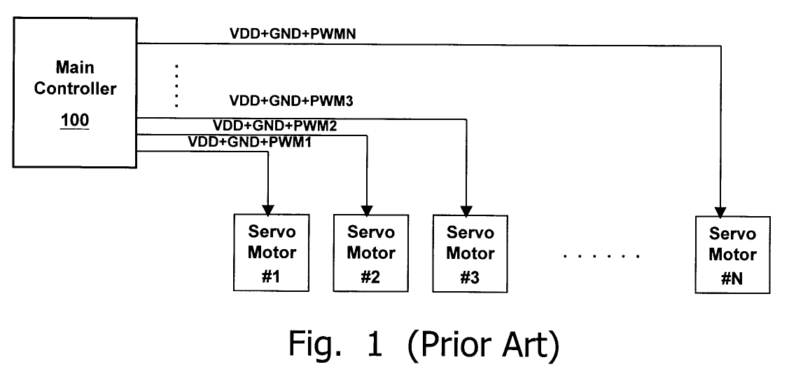

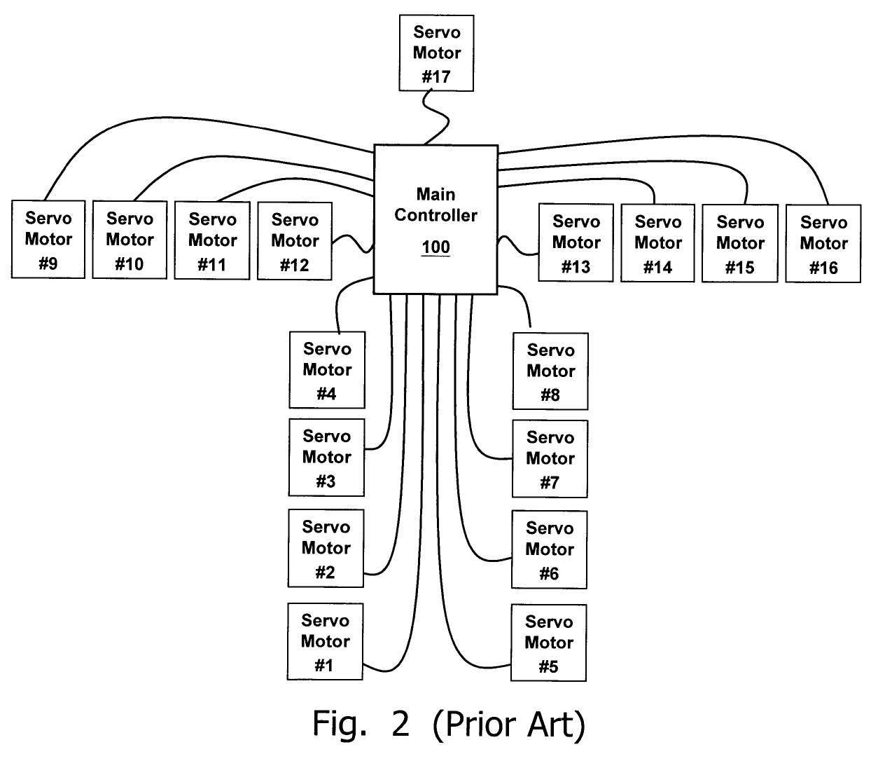

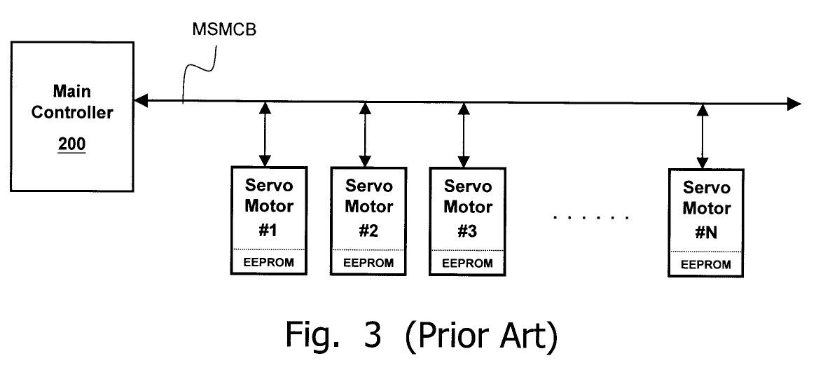

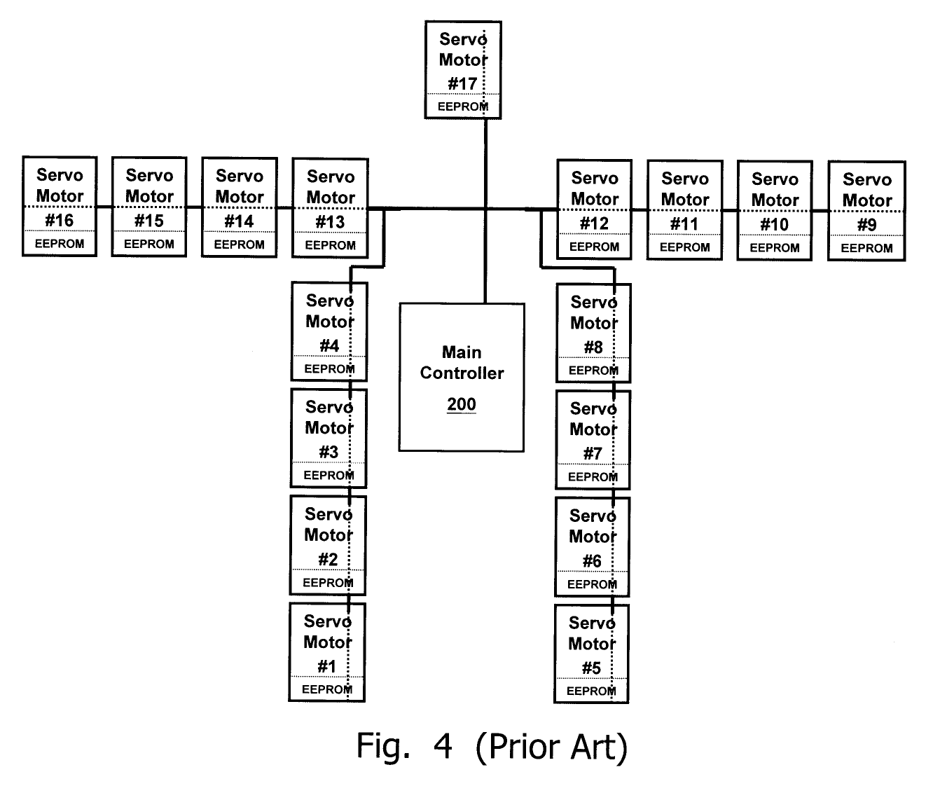

### DESCRIPTION OF THE PREFERRED EMBODIMENT

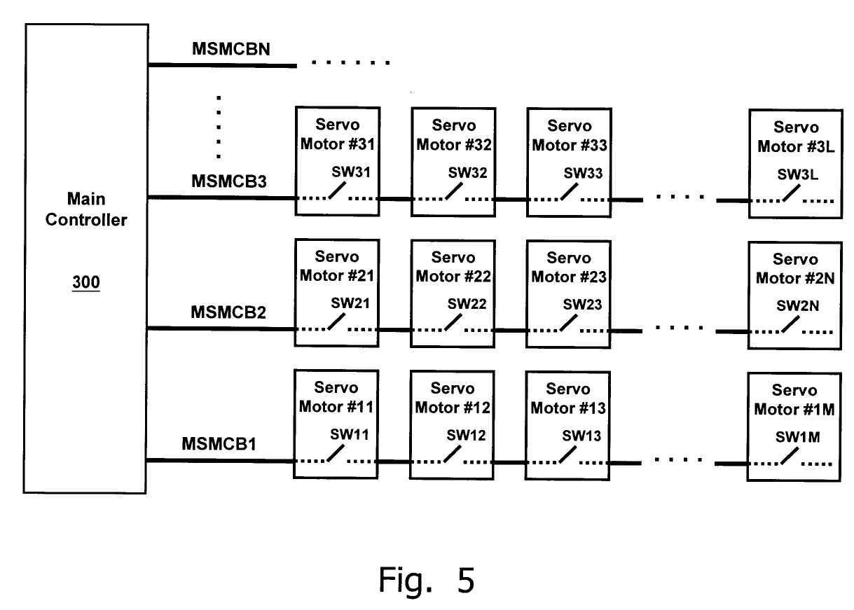

FIG. 5 schematically shows an embodiment of the present invention, in which each servo motor has three lines: VDD (not shown), GND (not shown), and MSMCB. The MSMCB can operate according to a protocol such as I²C, UART, or a user-defined protocol. There can be one or more signal lines; by way of example, FIG. 5 shows only one signal line.

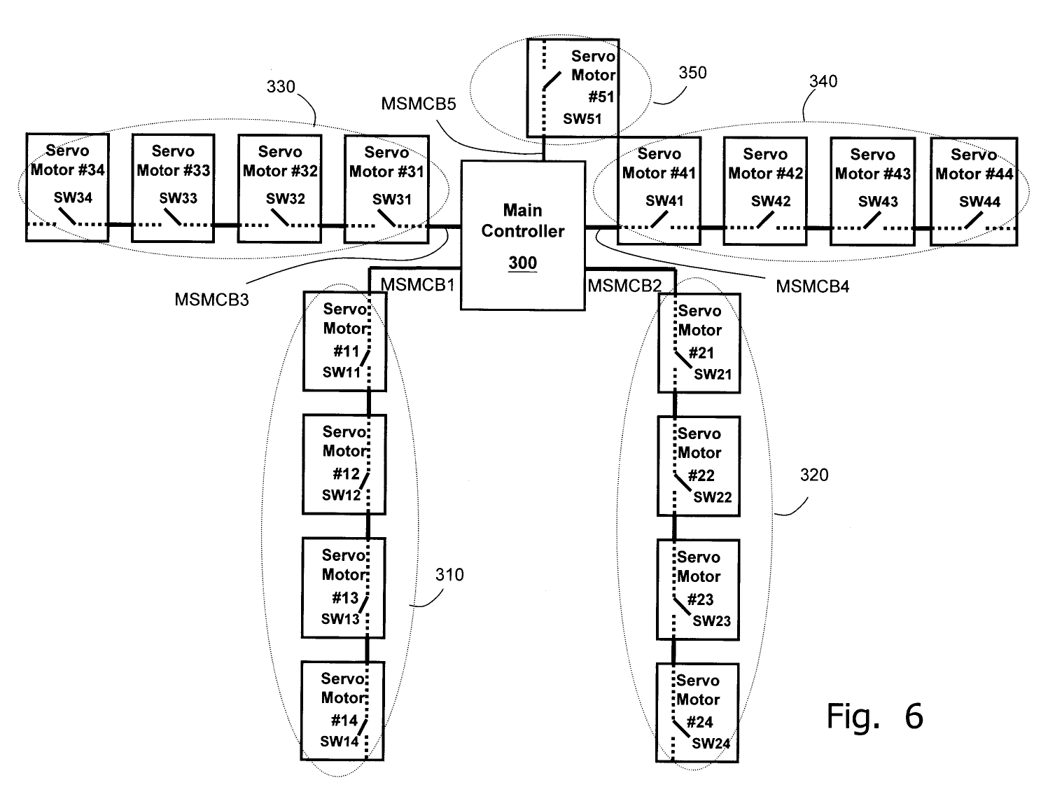

In this embodiment, the servo motors are connected partially in series and partially in parallel. More specifically, the servo motors are grouped into several strings according to their locations; a first string includes M servo motors, a second string includes N servo motors, a third string includes L servo motors, . . . , and so on, wherein M, N and L are positive integers that may be equal or not equal to one another. As an example where the present invention is applied to a human-like robot, referring to FIG. 6, a first string 310 includes four servo motors #11-#14 to operate the right leg of the robot; a second string 320 includes four servo motors #21-#24 to operate the left leg of the robot; a third string 330 includes four servo motors #31-#34 to operate the right hand of the robot; a fourth string 340 includes four servo motors #41-#44 to operate the left hand of the robot; and a fifth string 350 includes one servo motor #51 to operate the head of the robot.

Note that FIG. 6 is only one example among many possible variations. The servo motors may be grouped into different number of strings, and the number of servo motors in each string may be arranged otherwise. To connect the servo motors partially in series and partially in parallel provides the advantages that the layout of the servo motors is in a neat order, that the assembly of the servo motors is easy, and that efficiency for the main controller to control each servo motor (the bandwidth for the communication between the main controller and each servo motor) is better. However, the present invention is also applicable to the arrangement where all servo motors are connected in series.

The main controller 300 communicates with the servo motor strings 310-350 through corresponding buses MSMCB1-MSMCB5, respectively. The main controller can send commands to the servo motors, and the servo motors can report their status information to the main controller so that the main controller knows the condition of each servo motor, such as its location and whether an over current condition occurs, etc.

Because more than one servo motor share one MSMCB, each servo motor has to be assigned an ID so that the main controller 300 can identify a target servo motor with which it intends to communicate. Here a key difference between the present invention and prior art resides. According to this invention, the same servo motor can be used in any location, either during assembly or during maintenance. It is not required to provide an EEPROM in the servo motor, nor to preset its ID. In the present invention, an ID of each servo motor is automatically set during system initialization. Thus, the present invention saves hardware cost, and solves the ID setting trouble in assembly and maintenance.

More specifically, referring to FIG. 5 which shows the string of servo motors in MSMCB1 as an example, each servo motor has a corresponding switch SW11-SW1M provided on the MSMCB line. Each switch has a default state OFF during system initialization. Therefore, any signal from the main controller 300 will not pass forward. In one embodiment, the IDs of all the servo motors are 0 initially, indicating that the IDs have not been set yet. If the ID of a servo motor is 0, and it receives an ID setting command from the main controller 300, it takes the command as “to set its own ID”. At receiving such command, a servo motor sets its own ID, and turns ON its switch so that the servo motor next to it is capable of receiving signals from the main controller 300. In other words, a servo motor will not receive any command before an ID of a previous servo motor is set. In this manner, the main controller 300 sets an ID for every servo motor sequentially. After a corresponding ID is assigned to every servo motor, each servo motor begins to communicate with the main controller 300 bi-directionally on the MSMCB according to a predefined protocol. A servo motor located between the main controller 300 and a target servo motor functions as a signal repeater to pass a signal forward.

The initial ID of a servo motor can be any number other than 0, of course. “0” is only an example.

The last servo motor #1M does not have to turn ON its switch SW1M, so its circuit structure does not have to be the same as the other servo motors in the string. However, it is preferable to use a servo motor having the same circuit structure as that of the others for the benefit of easier management and programming.

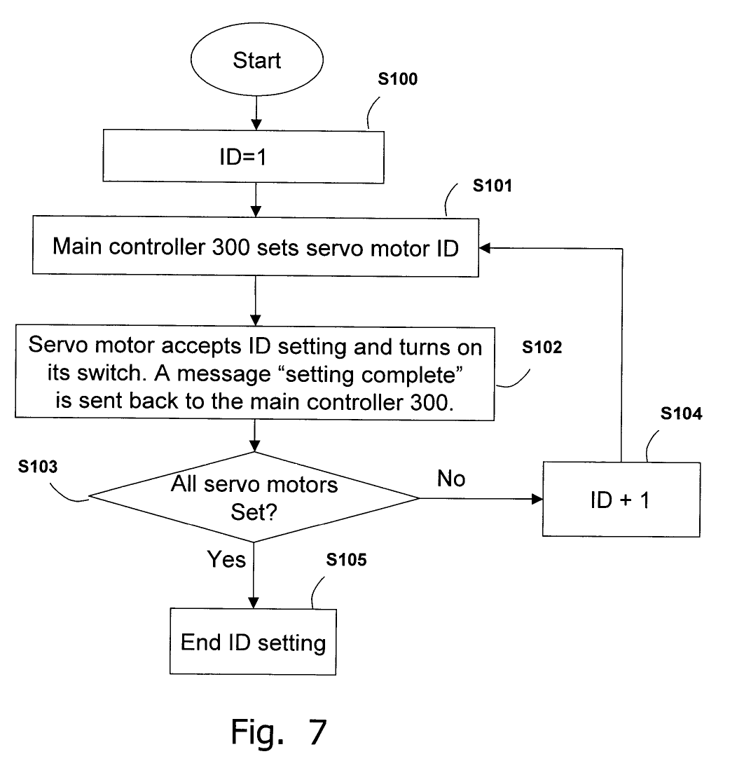

FIG. 7 shows the process flow for setting the IDs to the servo motors. The initial ID of every servo motor is 0. In step S100, the ID number 1 is given. Next in step S101, the main controller 300 sends a command to set the ID of the first servo motor. In step S102, the servo motor sets its own ID and turns ON its switch. It also responds a message to the main controller 300 to acknowledge that its ID has been set. In step S103, the system checks whether the IDs of all servo motors have been set, for example by predefining the total number of the servo motors in the main controller 300, or by a time-out mechanism which detects whether there is any servo motor responding within a given time period, etc. If it is required to set an ID for another servo motor, the flow goes to the step S104, in which the ID number changes, such as increasing by 1, and the flow further goes back to the step S101. If the IDs of all servo motors have been set, the flow ends (step S105). Of course, the ID number does not necessarily have to increase by 1; other arrangements are fine as long as different IDs are assigned to different servo motors.

In case the servo motors are connected partially in series and partially in parallel, such as the arrangement shown in FIG. 5, the main controller 300 can sequentially set the IDs of the servo motors one string after another. For example, the main controller 300 can set the IDs of the servo motors #11-#1M through MSMCB1, and next set the IDs of the servo motors #21-#2N through MSMCB2, and so on. In this manner, the IDs of all servo motors can be set in a logical order.

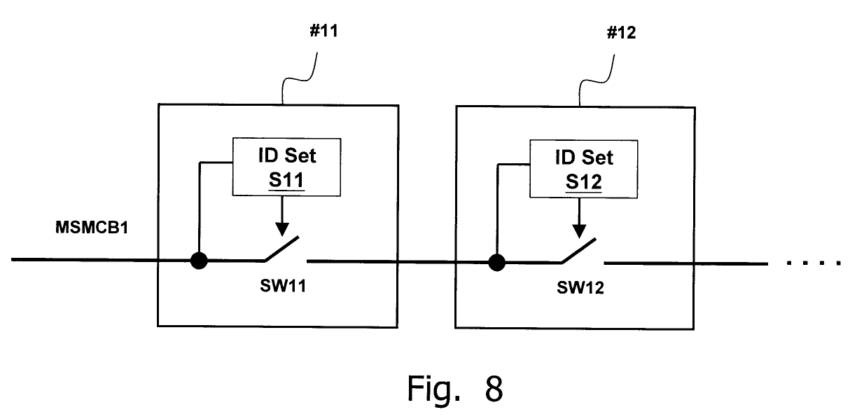

As to how a servo motor sets its ID and turns ON a corresponding switch according to the signal from the main controller 300, there are several software and hardware approaches to achieve the effect. FIG. 8 shows an approach in which the servo motor #11 includes an ID set unit S11 (the other circuits in the servo motor, such as a motor driver, a motor, etc., are omitted from the figure for simplicity, because they are irrelevant to the present invention). In one embodiment, this ID set unit S11 is a register of only a few digits, instead of an EEPROM. After the ID set unit S11 is set, it generates a signal to turn ON the switch S11.

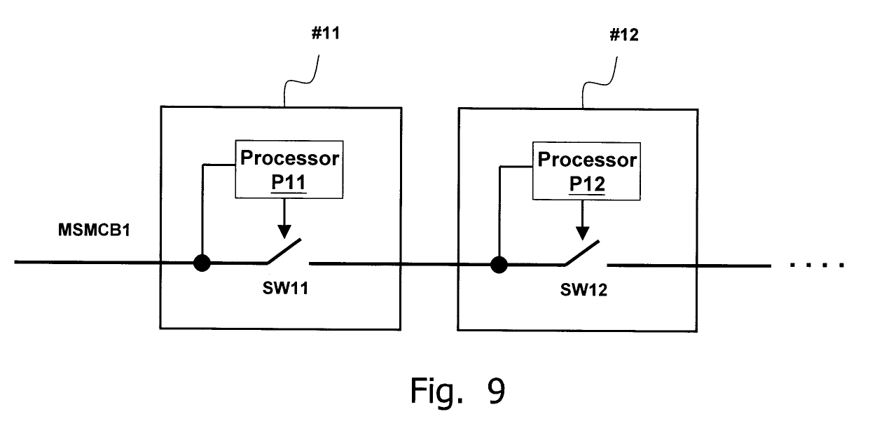

FIG. 9 shows another approach, in which a processor P11 in the servo motor #11 stores the ID by software, such as storing the ID in a predetermined address in a memory (not shown), and the processor P11 sends a signal to turn ON the switch S11.

After the switch S11 is ON, the servo motor #12 is capable of receiving a command from the main controller 300 to set its ID.

One skilled in this art can readily think of variations other than FIGS. 8 and 9 under the teaching of the present invention.

The “switch” described in the foregoing context can be a physical hardware switch, or a software switch (such as a flag, a program sequence, etc.).

In summary, an important feature of the present invention is to provide a corresponding switch on an MSMCB for at least every servo motor other than the last one; the switch is initially OFF, but turned ON after an ID is set to the servo motor, so that a next servo motor can receive signals from the main controller. The present invention provides the advantages that (1) it saves the cost of EEPROMs; (2) it solves the trouble of manually setting IDs in assembly and maintenance, because the IDs are automatically set during system initialization; (3) if the servo motors are connected partially in series and partially in parallel (optional), the main controller can control the servo motors with better efficiency, the system design is more flexible, and the layout is neat and easier to manage.

The features, characteristics and effects of the present invention have been described with reference to its preferred embodiments, which are provided only for illustrative purpose. Various other substitutions and modifications will occur to one skilled in the art, without departing from the spirit of the present invention. For example, the applications of the present invention are not limited to human-like or mammal-like robots; it can be applied to any system which requires connecting and controlling multiple servo motors. Therefore, all such substitutions and modifications are intended to be embraced within the scope of the invention as defined in the appended claims.

What is claimed is:

1. A system for controlling multiple servo motors, comprising:
a main controller;
a first plurality of servo motors; and
a first multiple servo motor control bus (MSMCB) for bi-directional communication between the main controller and each servo motor, the first MSMCB connecting the first plurality of servo motors in series,
wherein at least every servo motor other than the last one includes a corresponding switch on the first MSMCB, each switch being initially OFF, and turned ON after an ID is set to its corresponding servo motor, whereby a next servo motor is capable of receiving a signal from the main controller.

2. The system of claim 1, wherein the last servo motor includes a corresponding switch on the first MSMCB.

3. The system of claim 1, further comprising at least another servo motor not connected with the first plurality of servo motors in series.

4. The system of claim 3, comprising two or more strings of servo motors, the first string of servo motors being the first plurality of servo motors, the second string of servo motors being a second plurality of servo motors including the another servo motor and connected by a second MSMCB.

5. The system of claim 1, wherein each servo motor includes a unit for storing an ID.

6. The system of claim 1, wherein each servo motor includes a unit for turning ON the corresponding switch.

7. A servo motor, comprising:
a motor driver;
a motor;
an ID storing unit for storing an ID; and
a switch located on a bus, the bus providing communication with a device external to the servo motor, wherein the switch is initially OFF, and turned ON after an ID is stored to the ID storing unit.

8. The servo motor of claim 7, further comprising a unit for turning ON the switch.

9. A method for controlling multiple servo motors, comprising:
connecting a first plurality of servo motors in series;
providing a corresponding switch in the series connection path for at least every servo motor other than the last one;
sequentially setting an ID to each servo motor except the last one, and turning ON the corresponding switch; and
setting an ID to the last servo motor.

10. The method of claim 9, further comprising: providing a corresponding switch for the last servo motor; and turning ON the switch corresponding to the last servo motor after setting an ID to the last servo motor.

11. The method of claim 9, further comprising: providing at least another servo motor not connected with the first plurality of servo motors in series.

12. The method of claim 9, further comprising: providing a second plurality of servo motors, the first plurality of servo motors and the second plurality of servo motors are separately grouped into two strings.
